(19) United States
(12) Patent Application Publication
(10) Pub. No.: US 2019/0048634 A1
(43) Pub. Date: Feb. 14, 2019

(54) HINGES

(71) Applicant: Frameless Direct Pty Ltd, Somerton (AU)

(72) Inventor: Chris Sevastopoulos, Somerton (AU)

(21) Appl. No.: 16/103,568

(22) Filed: Aug. 14, 2018

(30) Foreign Application Priority Data
Aug. 14, 2017 (AU) 2017216444

(51) Int. Cl. E05D 7/086; E05D 5/02; E05D 3/02

(52) U.S. Cl. CPC E05D 7/086; E05D 2003/025; E05D 3/02; E05D 5/0246

(57) ABSTRACT

An unbiased hinge comprises a first leaf having a first front leaf plate, a first rear leaf plate and a first intermediate leaf member connected between the first front leaf plate and the first rear leaf plate. The hinge comprises a second leaf hingedly coupled to the first leaf, the second leaf having a second front leaf plate, a second rear leaf plate and a second intermediate leaf member connected between the second front leaf plate and the second rear leaf plate. The hinge comprises at least one dampener having a body received within the first or second intermediate leaf member and a shock absorbing member slidably received within the body of the at least one dampener to dampen hinged movement of the first leaf and the second leaf from an open position of the hinge toward a closed position of the hinge.

### CROSS-REFERENCE TO RELATED APPLICATION

This application claims priority to AU Patent Application No. 2017216444, filed Aug. 14, 2017, the disclosure of which is hereby incorporated by reference in its entirety.

### FIELD OF THE INVENTION

The invention relates to hinges. In particular, the invention relates to, but is not limited, to a dampening hinge to dampen the closing of a door, gate, screen, barrier or the like attached to the hinge. It is envisaged that the invention is particularly well suited for use with glass doors, but it should be appreciated that the hinge can similarly be used for doors, gates, screens, barriers or the like constructed from other materials. Embodiments of the present invention are also directed to hinged arrangements comprising one or more of the dampening hinges.

### BACKGROUND TO THE INVENTION

Hinges are used in a wide range of applications to enable an element, such as a door or gate or the like, to swing between an open and closed position relative to another element, such as a wall, door frame, fence or barrier or the like.

Some hinges include one or more biasing elements or components, to bias the hinge toward a closed position once the hinge has been opened. Such hinges are often employed with doors or gates for pool fences for safety reasons and for shower screens or doors to ensure the screen or door has closed to prevent the egress of water. Examples of biasing elements or components include springs, such as torsion springs and magnets.

To mitigate vibrations and/or damage to doors and/or gates with such biasing elements or components, hinges have been developed with one or more dampening elements that slow closure of the hinge. Such hinges are often used with glass doors, screens and gates.

However, there are a number of drawbacks with such hinges. For example, mechanical wear can result in the biasing components providing insufficient force to bias the hinge to the closed position. In some hinges, incorporation of both the biasing components and the dampening elements can result in bulky and heavy hinges, which increases manufacturing costs, can result in limitations on the materials with which such hinges can be used. Such hinges can also have a complex construction, which contributes to the manufacturing costs and can increase the likelihood of failure.

Reference to background art herein is not to be construed as an admission that such art constitutes common general knowledge.

### OBJECT OF THE INVENTION

It is a preferred object of this invention to provide a hinge which overcomes or at least ameliorates one or more of the disadvantages or problems described above, or which at least provides a useful commercial alternative.

Other preferred objects of the present invention will become apparent from the following description.

### SUMMARY OF THE INVENTION

In one form, although not necessarily the only or the broadest form, the invention resides in an unbiased hinge comprising:

a first leaf having a first front leaf plate, a first rear leaf plate and a first intermediate leaf member connected between the first front leaf plate and the first rear leaf plate;

a second leaf hingedly coupled to the first leaf, the second leaf having a second front leaf plate, a second rear leaf plate and a second intermediate leaf member connected between the second front leaf plate and the second rear leaf plate; and

at least one dampener having a body received within the first or second intermediate leaf member and a shock absorbing member slidably received within the body of the at least one dampener to dampen hinged movement of the first leaf and the second leaf from an open position of the hinge toward a closed position of the hinge.

Preferably, a neutral position of the shock absorbing member within the body of the at least one dampener is adjustable to adjust a position at which damping commences.

Preferably, the body of the at least one dampener comprises an external thread.

Preferably, the first or second intermediate leaf member comprises a recess having an internal thread for receiving the threaded body of the at least one dampener so that the neutral position of the body and thus the shock absorbing member can be adjusted.

Preferably, the at least one dampener comprises a dampening fluid, such as oil or air, within the body.

Preferably, the second leaf is hingedly coupled to the first leaf by a knuckle and pin assembly. More preferably, the second rear leaf plate is coupled to the first rear leaf plate by a knuckle and pin assembly.

Preferably, the first front leaf plate, the first rear leaf plate and the first intermediate leaf member each include at least one aperture for receiving a fastener to fasten the hinge to a surface, such as a door frame or a gate frame, wherein each of the apertures are aligned.

Preferably, the second front leaf plate, the second rear leaf plate and the second intermediate leaf member each include at least one aperture for receiving a fastener to fasten the hinge to a door or a gate, wherein each of the apertures are aligned.

Preferably, the second or first intermediate leaf member respectively has a recessed portion aligned with the shock absorbing member of the dampener.

Suitably, the hinge comprises two dampeners. Optionally, two dampeners are provided within the first intermediate leaf member or within the second intermediate leaf member. Alternatively, one dampener is provided within the first intermediate leaf member and one dampener is provided within the second intermediate leaf member.

Preferably, the hinge according to the present invention is used in conjunction with a conventional second hinge comprising at least one biasing element to bias the door or gate or the like from an open position toward a closed position. Hence, the conventional hinge provides the biasing force to close the door or gate or the like and the hinge according to the present invention dampens the closing of the door or gate or the like.

Hence, in another form, although not necessarily the only or the broadest form, the invention resides in a hinged arrangement comprising:

a first hinge hingedly attached to a door, gate, screen or barrier or the like, the first hinge comprising at least one biasing element to bias the door or gate or screen or barrier or the like towards a closed position; and

a second hinge according to the present invention hingedly attached to the door, gate, screen or barrier or the like to dampen movement of the door, gate, screen or barrier or the like towards the closed position.

Preferably, a closing force provided by the at least one biasing element of the first hinge is adjustable.

Further features and/or forms of the present invention will become apparent from the following detailed description.

### BRIEF DESCRIPTION OF THE DRAWINGS

By way of example only, preferred embodiments of the invention will be described more fully hereinafter with reference to the accompanying figures, wherein:

FIG. 1 illustrates a perspective view of an unbiased hinge in an open position according to an embodiment of the present invention;

FIG. 2 illustrates a detail of the dampener of the hinge shown in FIG. 1;

FIG. 3 illustrates a front view of the hinge of FIG. 1 in a closed position;

FIG. 4 illustrates a plan view of the hinge of FIG. 1 in the closed position;

FIG. 5 illustrates a detail of the dampener of the hinge in the closed position shown in FIG. 4;

FIG. 6 illustrates a side view of the hinge of FIG. 3;

FIG. 7 illustrates a cross-sectional view of the hinge shown in FIG. 6 in the along line F-F;

FIG. 8 illustrates an internal detail of the dampener of the hinge shown in FIG. 7;

FIG. 9 is a perspective view of a conventional hinge in a closed position used in conjunction with the hinge according to embodiments of the present invention;

FIG. 10 is a side view of the conventional hinge shown in FIG. 9;

FIG. 11 is a sectional view of the conventional hinge shown in FIG. 10 along line A-A;

FIG. 12 is a sectional view of the conventional hinge shown in FIG. 10 along line B-B; and

FIG. 13 shows detail of the conventional hinge relating to adjusting the closing force provided by the conventional hinge.

### DETAILED DESCRIPTION OF THE DRAWINGS

Elements of the invention are illustrated in concise outline form in the drawings, showing only those specific details that are necessary to understanding the embodiments of the present invention, but so as not to clutter the disclosure with excessive detail that will be clear to those of ordinary skill in the art in light of the present description.

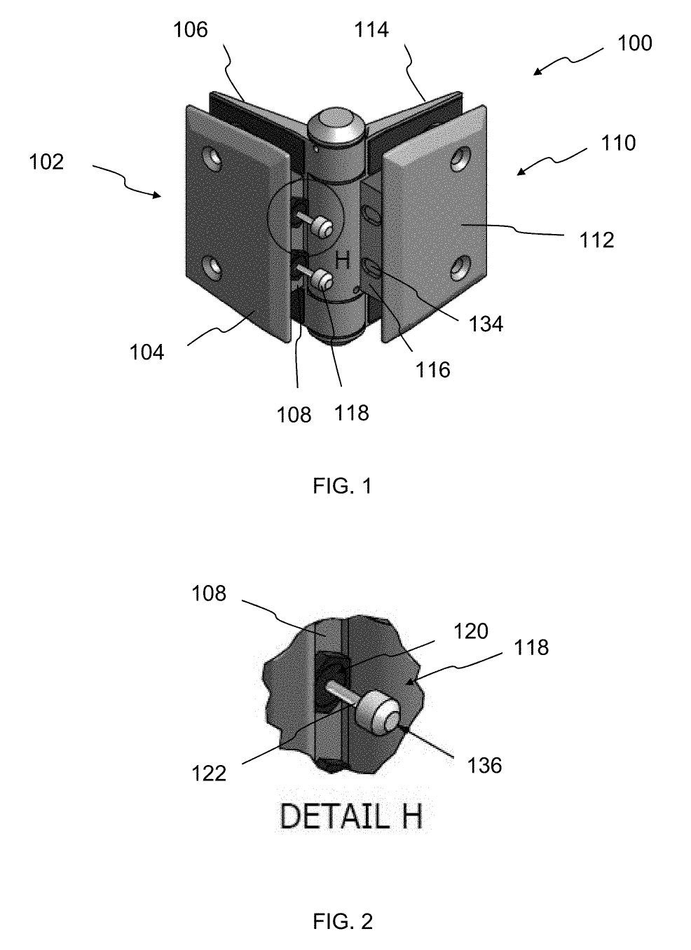

FIG. 1 illustrates an unbiased hinge 100 according to an embodiment of the present invention. Hinge 100 comprises a first leaf 102 having a first front leaf plate 104, a first rear leaf plate 106 and a first intermediate leaf member 108 connected between the first front leaf plate 104 and the first rear leaf plate 106. Hinge 100 comprises a second leaf 110 hingedly coupled to the first leaf 102. The second leaf 110 has a second front leaf plate 112, a second rear leaf plate 114 and a second intermediate leaf member 116 connected between the second front leaf plate 112 and the second rear leaf plate 114.

Hinge 100 comprises at least one dampener 118 to dampen hinged movement of the first leaf 102 and the second leaf 110 from an open position of the hinge toward a closed position of the hinge. In the embodiment shown in FIG. 1, the hinge 100 comprises two dampeners 118 spaced apart from each other.

With additional reference to the enlarged view in FIG. 2, the at least one dampener 118 has a body 120 received within the first intermediate leaf member 108. In alternative embodiments, the body 120 of the at least one dampener 118 is received within the second intermediate leaf member 116. The at least one dampener 118 has a shock absorbing member 122 slidably received within the body 120 of the at least one dampener to dampen hinged movement of the first leaf 102 and the second leaf 110 from an open position of the hinge 100 toward a closed position of the hinge.

In preferred embodiments of the hinge 100, a neutral position of the shock absorbing member 122 within the body 120 of the at least one dampener is adjustable to adjust a position at which damping by the at least one dampener 118 commences. The neutral position can be considered to be the distance the shock absorbing member 122 extends from the body 120 when the hinge 100 is in the open position or partially open position and the opposing intermediate leaf member is not impinging upon the shock absorbing member 122 and thus not forcing the shock absorbing member 122 within the body 120.

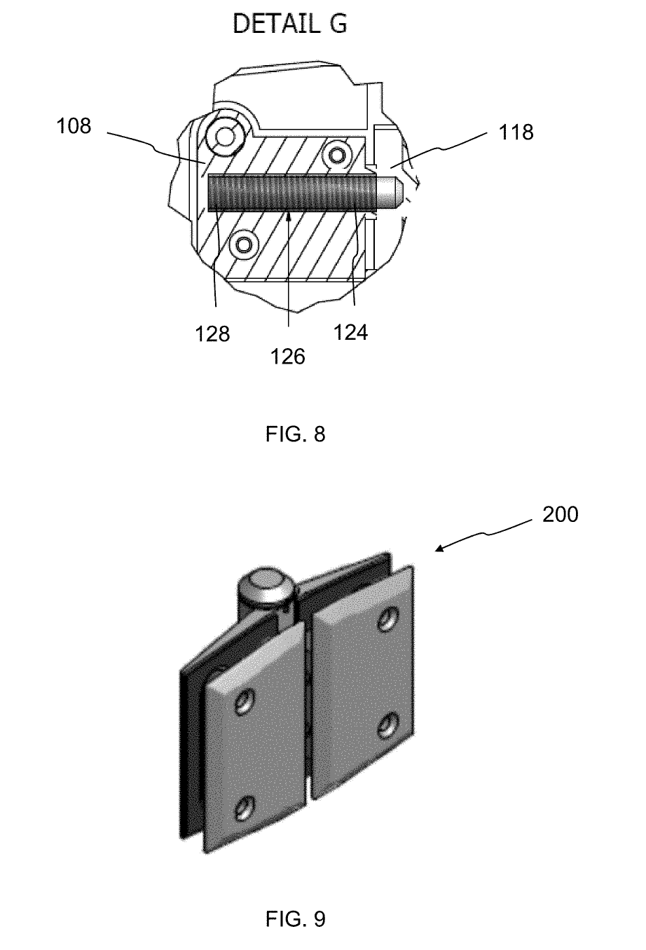

With particular reference to FIGS. 7 and 8, in preferred embodiments of the hinge 100, the body 120 of the at least one dampener 118 comprises an external thread 124. The first intermediate leaf member 108 and/or the second intermediate leaf member 116 comprises a recess or channel 126 having an internal thread 128 for receiving the threaded body 120 of the at least one dampener 118. The at least one dampener 118 can therefore be screwed into the channel 126 to the desired depth. Hence, the neutral position of the body 120 of the dampener, and thus the neutral position of the shock absorbing member 122, i.e. the position at which damping commences, can be adjusted.

In preferred embodiments of the hinge 100, the at least one dampener 118 comprises a dampening fluid, such as oil or air, within the body 120.

As shown in the drawings, in preferred embodiments of the hinge 100, the second leaf 110 is hingedly coupled to the first leaf 102 by a knuckle and pin assembly 129. More particularly, the second rear leaf plate 114 is coupled to the first rear leaf plate 106 by the knuckle and pin assembly 129.

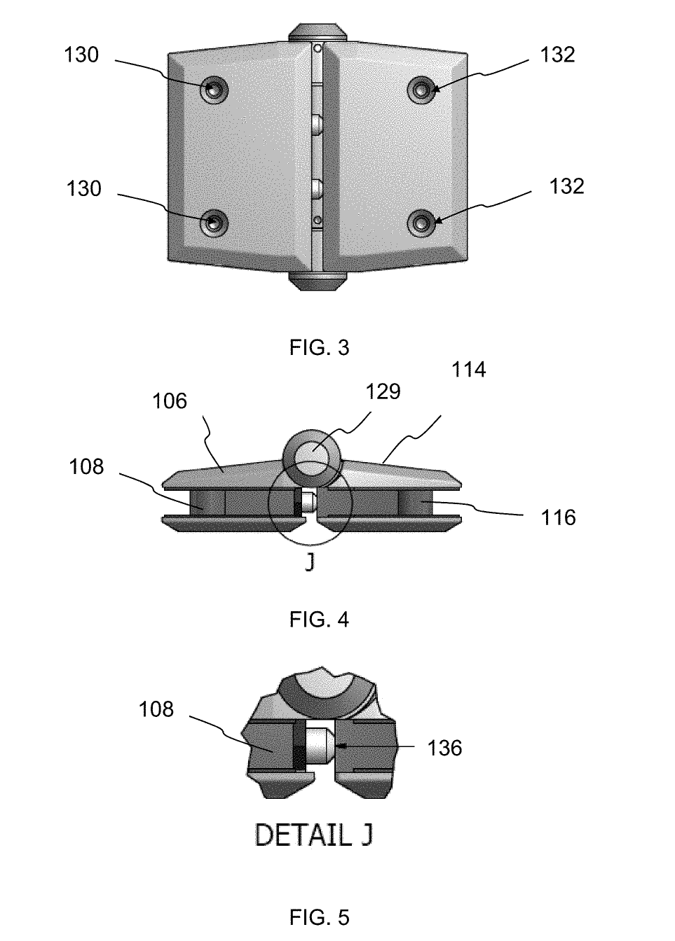

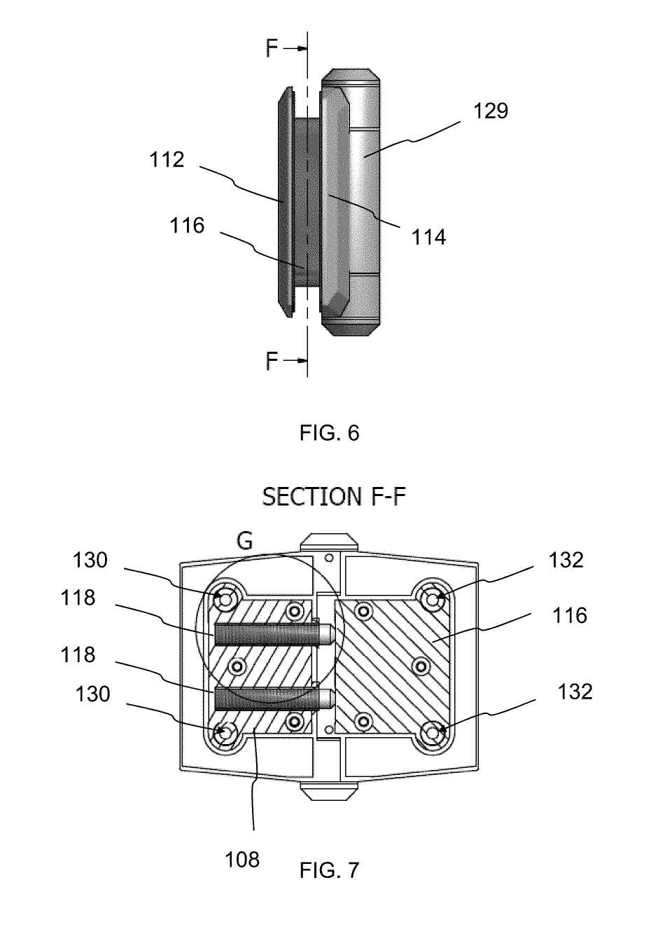

With reference to FIGS. 1, 3 and 7 in particular, in preferred embodiments of the hinge 100, the first front leaf plate 104, the first rear leaf plate 106 and the first intermediate leaf member 108 each include at least one aperture 130 for receiving a fastener, such as a screw, to fasten the hinge 100 to a surface, such as a door frame or a gate frame or a fence, wherein each of the apertures 130 are aligned. Similarly, the second front leaf plate 112, the second rear leaf plate 114 and the second intermediate leaf member 116 each include at least one aperture 132 for receiving a fastener, such as a screw, to fasten the hinge 100 to a door or a gate or screen or the like, wherein each of the apertures 132 are aligned.

With reference to FIG. 1, the second intermediate leaf member 116 or the first intermediate leaf member 108 respectively has a recessed portion or recess 134 that is aligned with the shock absorbing member 122 of the dampener 118 when the hinge 100 is in the closed position such that a head 136 of the shock absorbing member 122 is partially received within the recess 134. A recess 134 can be provided to partially receive the head 136 of a corresponding dampener 118.

As shown in FIGS. 1, 3 and 7, in some embodiments the hinge 100 comprises two dampeners 118. In some embodiments of the hinge 100, two dampeners 118 are provided within the first intermediate leaf member 108. Consequently, two recesses 134 are provided within the second intermediate leaf member 116. Alternatively, two dampeners 118 are provided within the second intermediate leaf member 116. Consequently, two recesses 134 are provided within the first intermediate leaf member 108. In other embodiments, one dampener 118 is provided within the first intermediate leaf member 108 and one dampener 118 is provided within the second intermediate leaf member 116. Consequently, one recess 134 is provided within the second intermediate leaf member 116 and one recess 134 is provided within the first intermediate leaf member 108.

It is envisaged that in some embodiments, more than two dampeners 118 are provided in the first and/or second intermediate leaf members 108, 116 if required by the particular application, for example, with a particularly large and/or heavy door, gate, screen or the like.

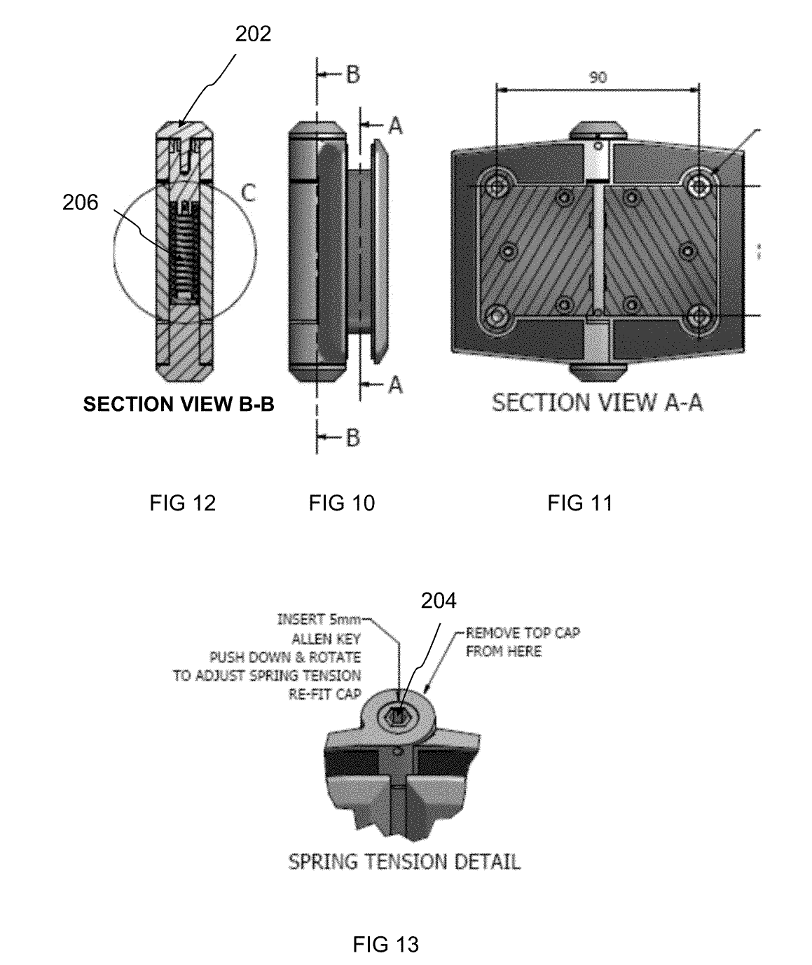

The hinge 100 according to the present invention is used in conjunction with a conventional second hinge comprising at least one biasing element, such as, but not limited to a torsion spring, to bias the door or gate or screen or the like from an open position towards a closed position. An example of a suitable conventional hinge 200 is shown in FIGS. 9-13. Hence, the conventional hinge 200 provides the biasing force to close the door or gate or screen or the like and the hinge 100 according to the present invention dampens the closing of the door or gate or screen or the like to avoid vibration and/or damage to the door or gate or screen or the like. The conventional hinge 200 can be attached at or towards the bottom of the door or gate or screen or barrier or the like and the hinge 100 according to the present invention can be attached at or towards the top of the door or gate or screen or barrier or the like or vice versa.

As shown in FIG. 13, an end cap 202 is removed from the conventional hinge 200 to allow access to a recess 204 for receiving an Allen key. Once the Allen key has been inserted in the recess 204, pushing down and rotating the Allen key allows the tension in the torsion spring 206 to be adjusted so the conventional hinge 200 closes with the desired force. Hence, a closing force provided by the at least one biasing element of the first, conventional hinge 200 is adjustable and can be matched according to the dampening force provided by the hinge 100 according to the present invention.

If the closing force provided by the at least one biasing element of the first, conventional hinge 200 is not adjustable, the one or more dampeners 118 of the hinge 100 according to the present invention can be selected according to the closing force provided by the conventional hinge(s) 200 available. Alternatively, or additionally, the position at which the dampeners 118 commence damping the closure of the hinges can be adjusted accordingly.

Hence, according to another form or aspect, the present invention resides in a hinged arrangement comprising a first conventional hinge 200 hingedly attached to a door, gate, screen or barrier or the like, the first conventional hinge 200 comprising at least one biasing element, such as a torsion spring 206, to bias the door or gate or screen or the like towards a closed position. The hinged arrangement comprises a second hinge 100 according to the present invention hingedly attached to the door, gate, screen or barrier or the like to dampen movement of the door, gate, screen or barrier or the like towards the closed position.

Hence, embodiments of the present invention address or at least ameliorate the aforementioned problems of the prior art by providing a hinge having one or more dampeners to slow the closure of the hinge thus reducing vibration and damage upon closure to both the hinge and the door, gate, barrier or the like connected to the hinge. The hinge of the present invention uses less material and has a relatively simple construction compared with at least some of the prior art hinges, thus reducing manufacturing costs and likelihood of failure. The hinge of the present invention is used with a conventional biasing hinge as described herein which avoids the need for two “specialist” hinges to be used and enables one of a pair of conventional hinges already in use to be replaced with the hinge of the present invention. The adjustable nature of the one or more dampeners enables the position at which damping commences to be finely tuned, thus maximising the utility of the hinge of the present invention. The one or more dampeners can be selected according to the level of dampening required for the particular application. Therefore, the hinge of the present invention is more versatile than many of the prior art hinges because the same hinge structure can be used for different applications with one or more differently rated dampeners. Omission of a biasing element, such as a torsion spring, from the hinge of present invention provides a hinge with a longer useful life compared with at least some of the prior art hinges.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step, etc.

Furthermore, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the scope of the above described invention.

What is claimed is:

1. An unbiased hinge comprising:
a first leaf having a first front leaf plate, a first rear leaf plate and a first intermediate leaf member connected between the first front leaf plate and the first rear leaf plate;
a second leaf hingedly coupled to the first leaf, the second leaf having a second front leaf plate, a second rear leaf plate and a second intermediate leaf member connected between the second front leaf plate and the second rear leaf plate; and
at least one dampener having a body received within the first or second intermediate leaf member and a shock absorbing member slidably received within the body of the at least one dampener to dampen hinged movement of the first leaf and the second leaf from an open position of the hinge toward a closed position of the hinge;
wherein the first leaf is unbiased in relation to the second leaf.

2. The hinge of claim 1, wherein a neutral position of the shock absorbing member within the body of the at least one dampener is adjustable to adjust a position at which damping commences.

3. The hinge of claim 2, wherein the body of the at least one dampener comprises an external thread and the first or second intermediate leaf member comprises a recess or channel having an internal thread for receiving the threaded body of the at least one dampener.

4. The hinge of claim 1, wherein the second or first intermediate leaf member respectively has a recessed portion aligned with the shock absorbing member of the dampener provided in the first or second intermediate leaf member.

5. The hinge of claim 1, wherein the hinge comprises two dampeners.

6. The hinge of claim 5, wherein two dampeners are provided within the first intermediate leaf member.

7. The hinge of claim 5, wherein two dampeners are provided within the second intermediate leaf member.

8. The hinge of claim 5, wherein one dampener is provided within the first intermediate leaf member and one dampener is provided within the second intermediate leaf member.

9. The hinge of claim 6, wherein the second intermediate leaf member has two recessed portions, one recessed portion aligned with a respective shock absorbing member of a respective one of the dampeners provided in the first intermediate leaf member.

10. The hinge of claim 7, wherein the first intermediate leaf member has two recessed portions, one recessed portion aligned with a respective shock absorbing member of a respective one of the dampeners provided in the second intermediate leaf member.

11. The hinge of claim 8, wherein the second intermediate leaf member has a recessed portion aligned with a shock absorbing member of the dampener provided in the first intermediate leaf member and the first intermediate leaf member has a recessed portion aligned with a respective shock absorbing member of the dampener provided in the second intermediate leaf member.

12. The hinge of claim 1, wherein the at least one dampener comprises a dampening fluid, such as oil or air, within the body.

13. The hinge of claim 1, wherein the second rear leaf plate is hingedly coupled to the first rear leaf plate by a knuckle and pin assembly.

14. The hinge of claim 1, wherein the first front leaf plate, the first rear leaf plate and the first intermediate leaf member each include at least one first aperture for receiving a fastener to fasten the hinge to a surface, such as a door frame or a gate frame, wherein each of the first apertures are aligned.

15. The hinge of claim 1, wherein the second front leaf plate, the second rear leaf plate and the second intermediate leaf member each include at least one second aperture for receiving a fastener to fasten the hinge to a door or a gate, wherein each of the second apertures are aligned.

16. A hinged arrangement comprising:
a first hinge hingedly attached to a door, gate, screen or barrier or the like, the first hinge comprising at least one biasing element to bias the door, gate, screen or barrier or the like towards a closed position; and
a second hinge according to claim 1 hingedly attached to the door, gate, screen or barrier or the like to dampen movement of the door, gate, screen or barrier or the like towards the closed position.

17. The hinged arrangement of claim 16, wherein the first hinge is attached at or towards the bottom of the door, gate, screen or barrier or the like and the second hinge is attached at or towards the top of the door, gate, screen or barrier or the like or vice versa.

18. The hinged arrangement of claim 16, wherein a closing force provided by the at least one biasing element of the first hinge is adjustable.
